(19) United States
(12) Patent Application Publication
(10) Pub. No.: US 2024/0020214 A1
(43) Pub. Date: Jan. 18, 2024

(54) SYSTEM AND METHOD FOR GENERATING SERVICE TOPOLOGY GRAPH FOR MICROSERVICES USING DISTRIBUTED TRACING

(71) Applicant: VMWARE, INC., Palo Alto, CA (US)

(72) Inventors: Chandrashekhar JHA, Bangalore (IN); SIDDARTHA LAXMAN KARIBHIMANVAR, Bangalore (IN); ROHAN KUMAR JAIN, Bangalore (IN)

(21) Appl. No.: 17/958,463

(22) Filed: Oct. 3, 2022

(30) Foreign Application Priority Data
Jul. 15, 2022 (IN) 202241040594

(51) Int. Cl. G06F 11/32; G06F 11/07; G06F 11/34

(52) U.S. Cl. CPC G06F 11/323; G06F 11/079; G06F 11/3461

(57) ABSTRACT

A system and method for generating a service topology graph for microservices in a computing environment uses traces collected from the microservices to generate the service topology graph. The traces are processed to create nodes and edges of the service topology graph. A new node is created when a current trace being processed is a trace being processed for a first time and an edge is created between a node that is associated with a parent span of a current span being processed when the current span is a first span being processed for the current trace and the current span includes a parent span identification.

### RELATED APPLICATIONS

Benefit is claimed under 35 U.S.C. 119(a)-(d) to Foreign Application Serial No. 202241040594 filed in India entitled “SYSTEM AND METHOD FOR GENERATING SERVICE TOPOLOGY GRAPH FOR MICROSERVICES USING DISTRIBUTED TRACING”, on Jul. 15, 2022, by VMware, Inc., which is herein incorporated in its entirety by reference for all purposes.

### BACKGROUND

In recent years, there has been significant interest in adopting microservices instead of standalone monolithic architecture, which allows a single monolithic service to be split into multiple granular services. This interest in microservices is due to the fact that microservice architecture provides is popular benefits, such as modularity, scalability, cross-functional and independent services based on business needs.

However, microservice architecture does come with some challenges. Monitoring, managing and troubleshooting in microservices is a challenging task as there are now many services for what used to be a single monolithic service. Application logging is one approach used to help in debugging individual microservices. However, the main disadvantage with application logging is that analyzing application paths can be challenging because the application paths may follow numerous microservices. In addition, this analysis does not help in understanding the holistic view of applications.

Distributed tracing is another approach that can be used in microservices, which provides program flow/data progression across the microservices using traces. However, with increase in the number of microservices, the traces that need to be analyzed increases as well, which makes trace analysis difficult to execute.

### SUMMARY

A system and method for generating a service topology graph for microservices in a computing environment uses traces collected from the microservices to generate the service topology graph. The traces are processed to create nodes and edges of the service topology graph. A new node is created when a current trace being processed is a trace being processed for a first time and an edge is created between a node that is associated with a parent span of a current span being processed when the current span is a first span being processed for the current trace and the current span includes a parent span identification.

A computer-implemented method for generating a service topology graph for microservices in a computing environment in accordance with an embodiment of the invention comprises collecting traces from the microservices, wherein each of the traces includes at least one span, and processing the traces to create nodes and edges of the service topology graph, wherein the nodes represent the microservices and the edges are connections between the nodes, wherein the processing of the traces includes, for each of the traces, creating a new node in the service topology graph when a current trace being processed is a trace being processed for a first time, and processing the at least one span of the current trace, including creating an edge between a node that is associated with a parent span of a current span being processed and the new node when the current span is a first span being processed for the current trace and the current span includes a parent span identification. In some embodiments, the steps of this method are performed when program instructions contained in a non-transitory computer-readable storage medium are executed by at least one or more processors.

A system in accordance with an embodiment of the invention comprises memory and at least one processor configured to collect traces from microservices in a computing environment, wherein each of the traces includes at least one span, and process the traces to create nodes and edges of a service topology graph for the microservices, wherein the nodes represent the microservices and the edges are connections between the nodes, wherein the at least one process is configured to, for each of the traces, create a new node in the service topology graph when a current trace being processed is a trace being processed for a first time, and process the at least one span of the current trace, including creating an edge between a node that is associated with a parent span of a current span being processed and the new node when the current span is a first span being processed for the current trace and the current span includes a parent span identification.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a distributed system in accordance with an embodiment of the invention.

FIG. 2 is an example of a service topology graph generated by a service topology engine in the distributed system shown in FIG. 1 in accordance with an embodiment of the invention.

FIG. 3 are examples of a node data structure and an edge data structure used by the service topology engine in accordance with an embodiment of the invention.

FIG. 4 is a flow diagram of a process for generating a service topology graph for microservices running in a data center in the distributed system shown in FIG. 1 in accordance with an embodiment of the invention.

FIG. 5A shows a new node being created in a service topology being generated in accordance with an embodiment of the invention.

FIG. 5B shows the new node created in a service topology graph as having a detected failure in accordance with an embodiment of the invention.

FIG. 5C shows an edge being created in the service topology graph in accordance with an embodiment of the invention.

FIG. 5C shows an edge being created in the service topology graph in accordance with an embodiment of the invention.

FIG. 5D shows the service topology graph with all the nodes and edges in accordance with an embodiment of the invention.

FIG. 5E shows a deprecated node detected in the service topology graph that is visually indicated in the service topology graph in accordance with an embodiment of the invention.

FIG. 5F shows a network bottleneck detected in the service topology graph that is visually indicated in the service topology graph in accordance with an embodiment of the invention.

FIG. 5G shows the data path through the service topology graph in accordance with an embodiment of the invention.

FIG. 6 is a diagram of a hybrid cloud computing environment in which microservices may be implemented in accordance with an embodiment of the invention.

FIG. 7 is a flow diagram of a computer-implemented method for generating a service topology graph for microservices in a computing environment in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

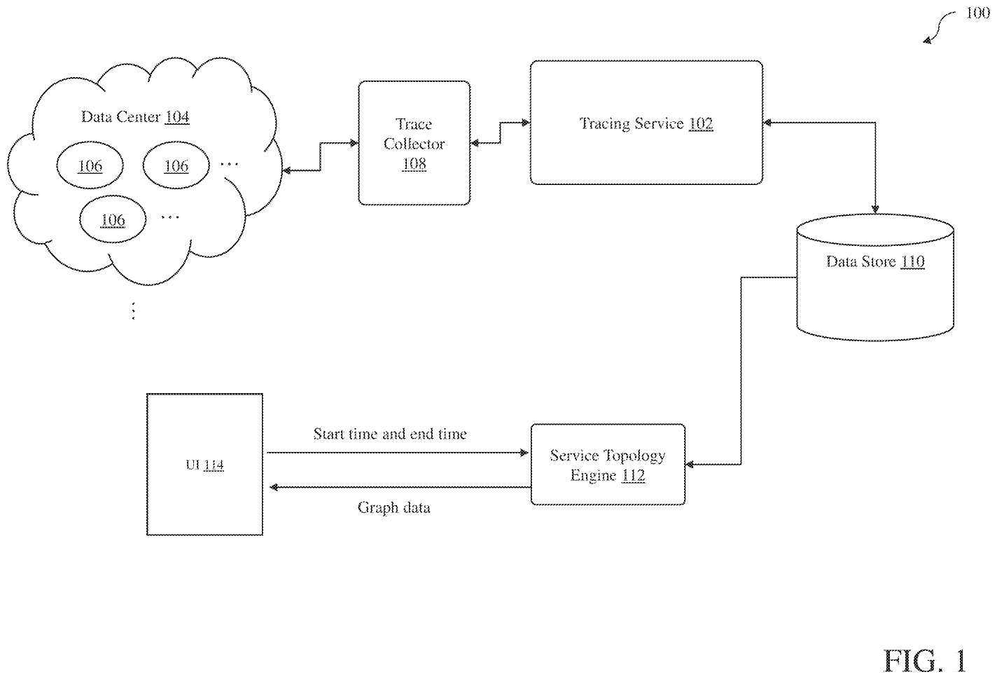

Turning now to FIG. 1, a diagram of a distributed system 100 in accordance with an embodiment of the invention is illustrated. As shown in FIG. 1, the distributed system 100 includes a tracing service 102, which provides trace management service to one or more data centers 104 to analyze microservices 106 running in the data centers. Each data center 104 includes compute, network and storage resources to run applications on the microservices 106. The data center 104 may an on-premises (on-prem) data center, a virtual data center in a public cloud computing environment, or a data center in a hybrid cloud computing environment. At least some of the data centers 104 may use distributed tracing to monitor applications using microservices and generate traces.

Distributed tracing helps in tracking each and every data path across an application stack, which may pass through many microservices. Distributed tracing may be achieved using well-known available libraries or any proprietary trace generation solution, to generate traces or multiple trace data. Some of the parameters that may be included in traces are (1) function calls, (2) time taken to complete a request, (3) connection details (e.g., in case of database connection), and (4) request statistics, such as success or failure.

Once tracing is enabled, traces for each set of actions triggered inside the microservices are generated. A trace is similar to a log, which is obtained from application logging. Whereas logs provide state of an application, traces provide details on a request, which spans across multiple microservices. Each trace can act as a point of view for analyzing the data path of an application and detecting failures. Multiple traces can be grouped into one single cluster of traces, which represents a unique data path for an application workflow. There can be many such groups or clusters of traces, which signifies corresponding business logic implemented in microservices. Traces will be described in more detail below.

In the illustrated embodiment, the tracing service 102 operates with a trace collector 108, which collects trace data from the data centers 104 and transmits the collected trace data to the tracing service 102. The trace collector 108 may work with components in the data centers 104 to receive the trace data. The tracing service 102 performs various operations to manage the collected trace data. Some of the operations performed by the tracing service 102 may include formatting the trace data and sending the traced data to a data store 110. The tracing service 102 and the trace collector 108 may be implemented as software running on an appropriate computing environment, such as on a public cloud or on one or more private clouds. In some embodiments, the trace collector 108 may be integrated into the tracing service 102.

The data store 110 is a repository to persistently store the trace data and any information related to the trace data. The data store 110 may utilize any database search solutions, such as, but not limited to, Structured Query Language (SQL), Apache Solr and Elasticsearch. As an example, the data store 110 will be described as using Apache Solr.

Debugging/troubleshooting the microservices 106 running in any computer environment, such as one of the data centers 104, is a tough task with increase in microservices deployed in a cluster. A program path can be defined as business workflow which might span across many microservices, for example, in e-commerce domain order management life cycle, user creation workflow, product search domain, etc. Let's take order management service (OMS) program path as an example. When a customer tries to buy a product, the backend system goes through a set of microservices, such as (1) order service (create and persist an invoice), (2) inventory service (check if there is inventory available for the order), (3) payment service (check for account balance and initiate payment process), and (4) delivery service (start the delivery process).

Traces help in bringing connections between the set of microservices for each of the program paths. A trace holds data about the existing code path and additional details, such as, request time, connection details, memory limits, etc. As previously mentioned, a trace can be thought of as a log in application logging. Each trace will usually have multiple spans, where each span holds details of each program path. Each span points to the next span using a pointer variable which explains the program path. A trace can have N number of spans, which typically involve different microservices. Hence, looking at a trace can hold some high level details of all the microservices involved in one single place.

Examples of traces or trace data that may be collected are shown below in Table 1, which include a trace from an inventory service and a trace from a payment service.

TABLE 1

| Trace from Inventory Service | Trace from Payment Service |
|---|---|
| { | { |
| host: inventory-service | host: payment-service |
| spans: | spans: |
| [{ | [{ |
| traceId: | traceId: |
| 45b53b3d24b3f5c4ce23212b81ffadfd | 45b53b3d24b3f5c4ce23212b81ffadfd |
| spanId: 111 | spanId: 113 |
| parentId: ″″ | parentId: 112 |
| status: SUCCESS | status: SUCCESS |
| requestTime: 12ms | requestTime: 1min |
| method: isInventoryAvailable( ) | method: triggerPaymentGateway( ) |
| }, | }, |
| { | { |
| traceid: | traceid: |
| 45b53b3d24b3f5c4ce23212b81ffadfd | 45b53b3d24b3f5c4ce23212b81ffadfd |
| spanId: 112 | spanId: 114 |
| parentId: 111 | parentId: 113 |
| status: SUCCESS | status: FAILURE |
| requestTime: 10min | requestTime: 1min |
| method: triggerPaymentGateway( ) | method: isBalanceAvailable( ) |
| }] | }....] |
| } | } |

As shown in Table 1, each microservice emits a trace or trace data that contains a list of spans. Some of the properties of a span may include (1) span identification (ID) or spanId (uniquely identifies a span), (2) trace ID or traceld (uniquely identifies a trace) and (3) parent ID or parentId (spanld of the previous span, which helps in connecting two spans), which may also be called parent span ID. In the above table, the trace data from the payment service has a span “114” (spanId) and parentId “112”, which is same as the spanId of a span “112” in the trace data from the inventory service. Thus, there is a connection from the span “112”, which is associated with the inventory service, to the span “114”, which is associated with the payment service. This is how a connection is made from two different microservices and forms a single unit of trace. Thus, traces may be used for troubleshooting processes.

However, a disadvantage with using trace data for troubleshooting processes is that there can be many program paths, which will increase the number of traces. Looking at each trace might require similar effort as looking at each log in each microservice, even though spans in the traces are connected over a set of microservices. Hence, an increase in the number of traces to review is directly proportional to the increase in the troubleshooting process.

In order to address this disadvantage, the distributed system 100 includes a service topology engine 112, which provides an efficient way to troubleshoot the microservices running in the data centers 104 using traces by bringing a holistic view of application workflows in the form of a directed graph that represent a service topology for connected microservices. This directed graph will be referred to herein as a service topology graph, which can act as one stop or the first step process in troubleshooting the microservices.

A service topology graph generated by the service topology engine 112 includes nodes, which represent microservices, and edges, which represent connections between the microservices. The service topology graph provides an easy-to-consume visual to analyze the microservices 106 running in each data center 104, which execute various operations for one or more applications. The service topology graph may also visually indicate which microservices has detected failures. As an example, a microservice with a failure may be illustrated as a node with a particular color, e.g., red, which is different than the other nodes without any detected failures. The service topology graph may also visually provide network latency measures on the edges so that network performance can be readily analyzed. In addition, the service topology graph may indicate deprecated nodes (i.e., nodes without connections to other nodes via edges) and/or network bottlenecks.

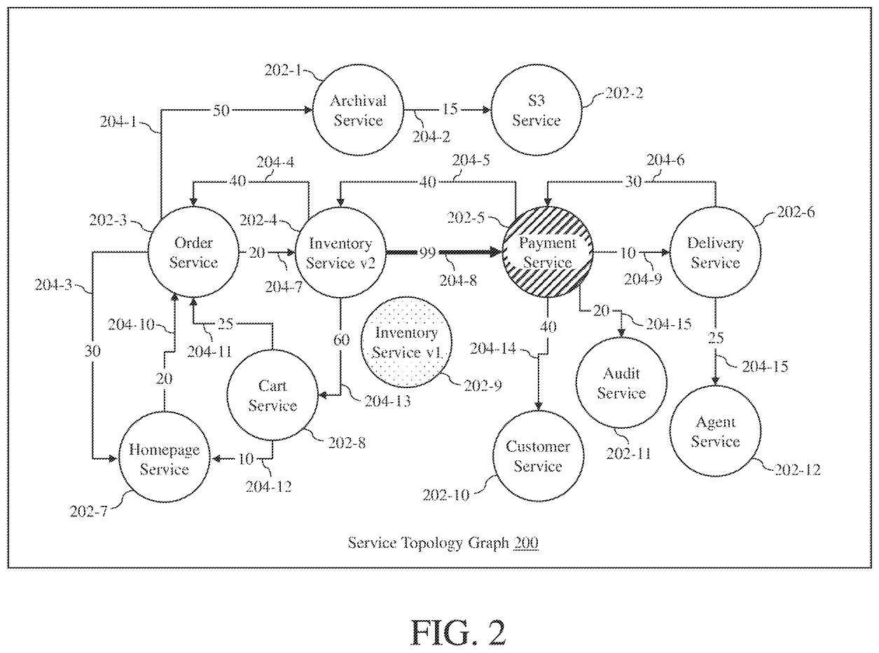

An example of a service topology graph 200 generated by the service topology engine 112 in accordance with an embodiment of the invention is shown in FIG. 2. The service topology graph 200 includes nodes 202-1 to 202-12, which are connected to each other by edges 204-1 to 204-16. In this example, the nodes represent microservices executing various services for an order management service. Each edge includes a network latency measure, e.g., a numerical value, which indicates network latency for the connection between two nodes represented by that edge. In this service topology graph 200, the node 202-5 for a payment service is illustrated as a failure detected node, which may be shown by using the color red for the node 202-5. In addition, the node 202-9 is illustrated as a deprecated node, which may be shown by using the color gray for the node 202-9. Furthermore, the edge 204-8 is illustrated as an edge having a network bottleneck, which may be shown by using a red arrow to represent the edge 204-8. Thus, the service topology graph 200 provides an easy-to-consume visual to show various issues regarding the microservices running on the data center.

The service topology engine 112 may use data structures to generate service topology graphs. The data structure for a service topology graph includes data structures for nodes and edges, which are the main components of the service topology graph.

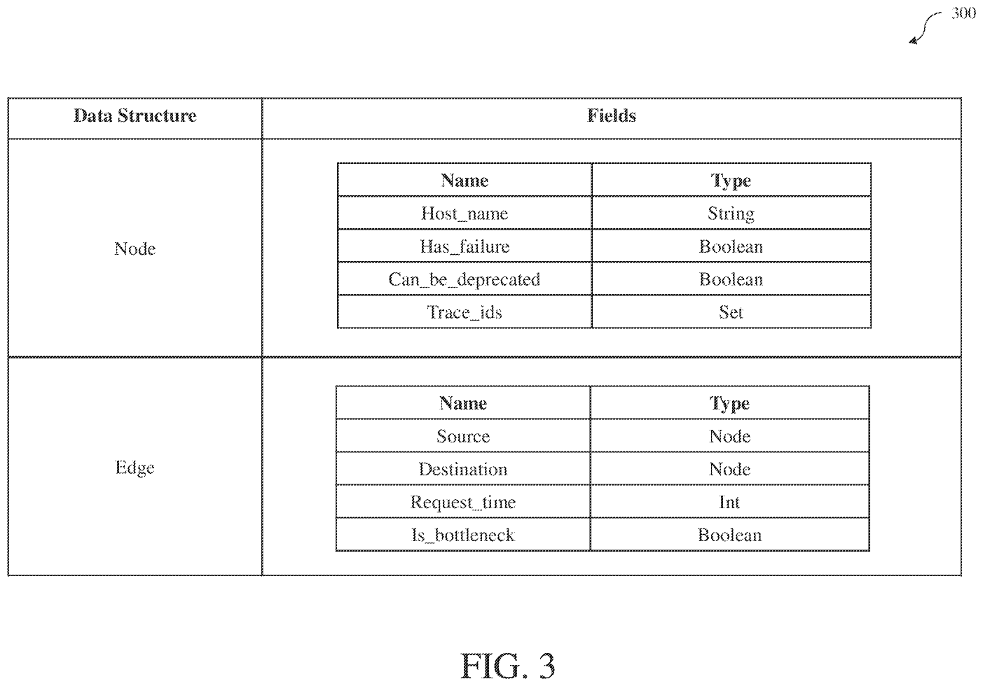

Examples of a node data structure and an edge data structure used by the service topology engine 112 in accordance with an embodiment of the invention are shown in a table 300 in FIG. 3. As illustrated in the table 300, properties of a node may include (1) Host_name (host name of a microservice), (2) Has_failure (failures found in this microservice), (3) Can_be_deprecated (has zero edges connected to this microservice, which indicates this service can be deprecated in the future), and (4) Trace_ids (holds a list of trace IDs found in this microservice). As also illustrated in the table 300, properties of an edge include (1) Source (source node from which a call has been triggered), (2) Destination (destination node where the call has reached), (3) Request_time (time taken to complete the request from source to destination), and (4) Is_bottleneck (signifies if a network connection is a bottleneck with respect to request time).

A request for a service topology graph for the microservices running in the data center may be made to the service topology engine 112 by a user, such as an administrator, using a user interface 114, which can be any user interface running on any system, such as a web-based user interface. In an embodiment, a request is made with a specified time range, which can be defined using a start time and an end time. The specified time range instructs the service topology engine 112 to use only trace data found during the specified time range. In response to the request, a service topology will be generated by the service topology engine 112 and the resulting data of the service topology graph or graph data is transmitted to the user interface 114, where the service topology graph is rendered by the user interface 114. The displayed service topology graph can then be used by the user to analyze the microservices, e.g., for troubleshooting.

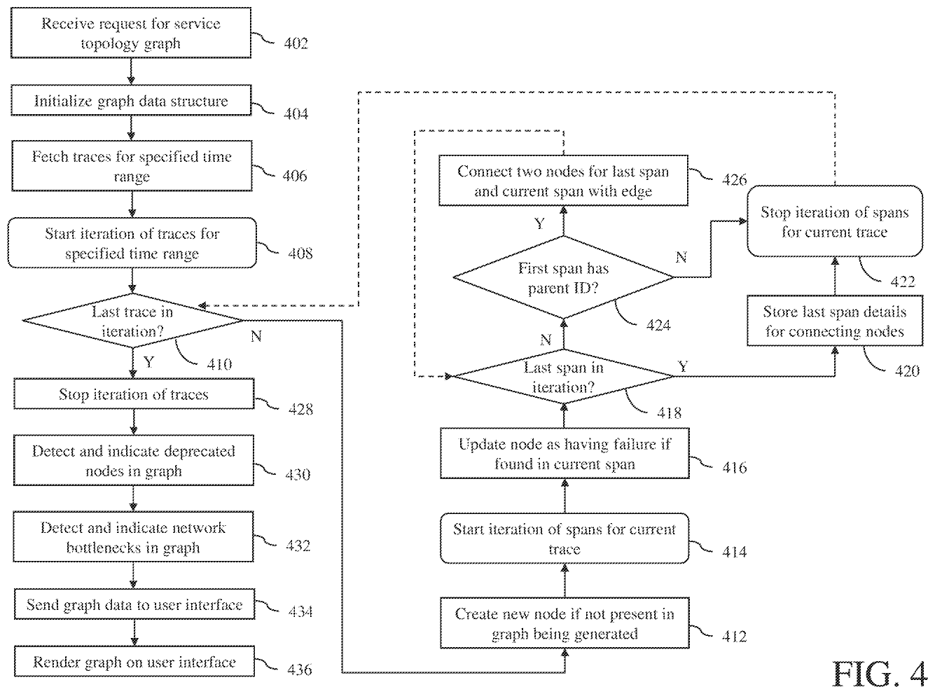

Turning now to FIG. 4, a flow diagram of a process for generating a service topology graph for the microservices 106 running in one of the data centers 104 in accordance with an embodiment of the invention is illustrated. The process begins at step 402, where a request for a service topology graph for the data center is received by the service topology engine 112 from a user, e.g., an administrator of the data center, via the user interface 114. In an embodiment, the request includes a specified time range or window, for which the service topology graph is to be generated. In other words, only traces collected during the specified time range are to be used to generate the service topology graph. The time range may be specified using a start time and an end time.

Next, at step 404, a graph data structure is initialized by the service topology engine 112 for the new service topology graph being generated. This graph data structure will be used to define nodes and edges that will be created for the requested service topology graph. Next, at step 406, traces within the specified time range are fetched from the data store 110 by the service topology engine 112. In an embodiment, distinct trace IDs for the specified time range are first fetched from the data store 110. Then, for each trace ID, all traces with the trace ID within the specified time range are fetched from the data store 110.

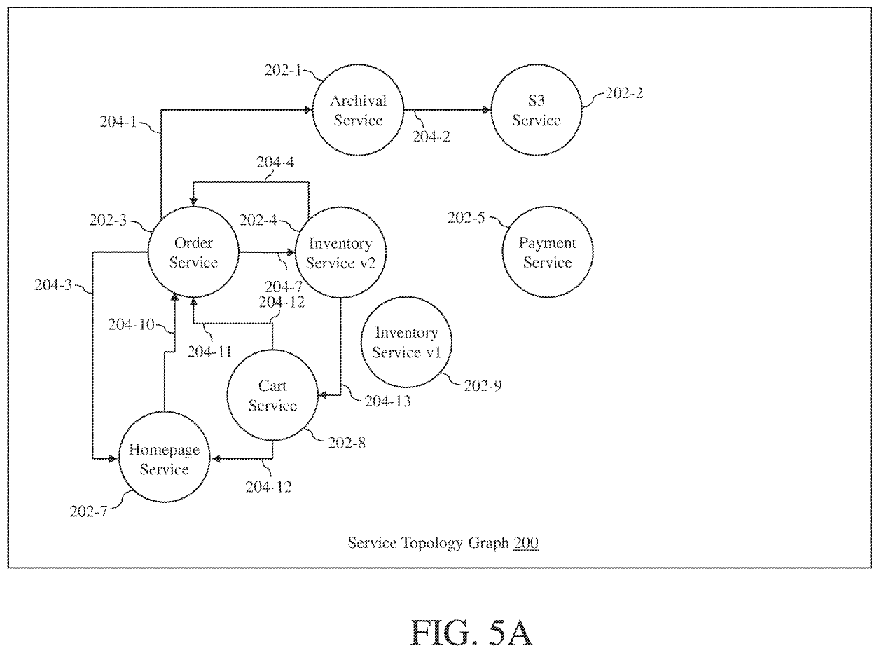

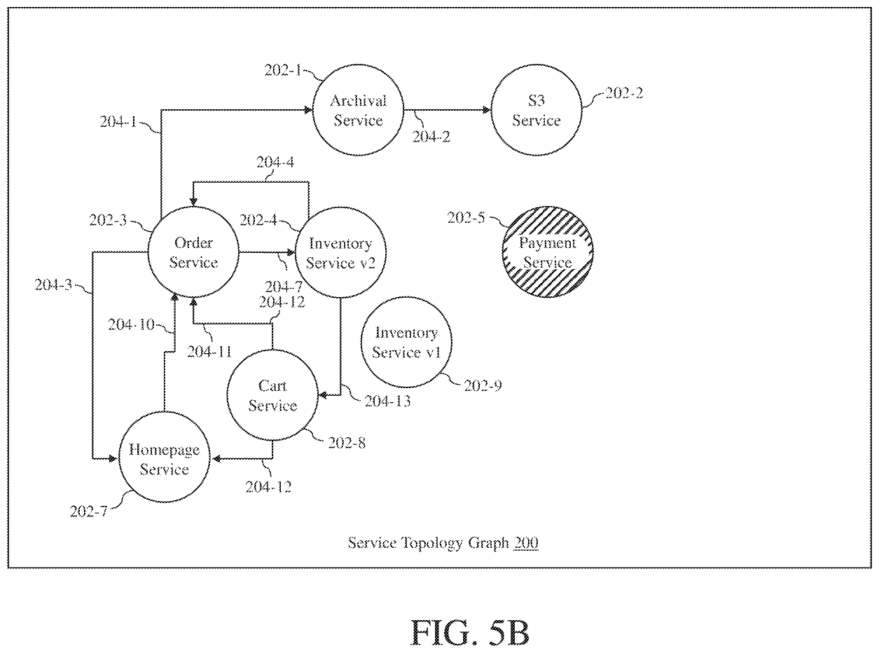

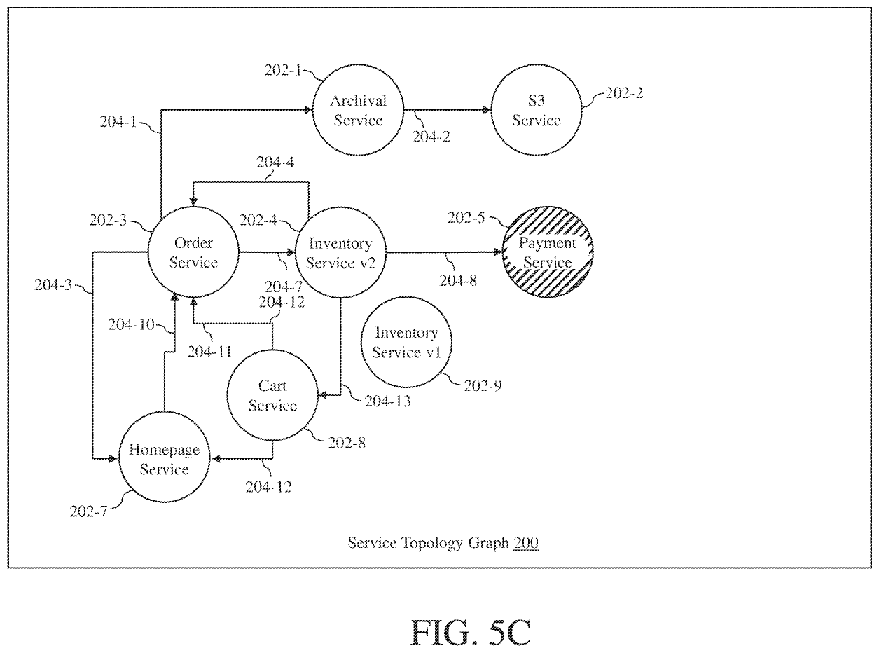

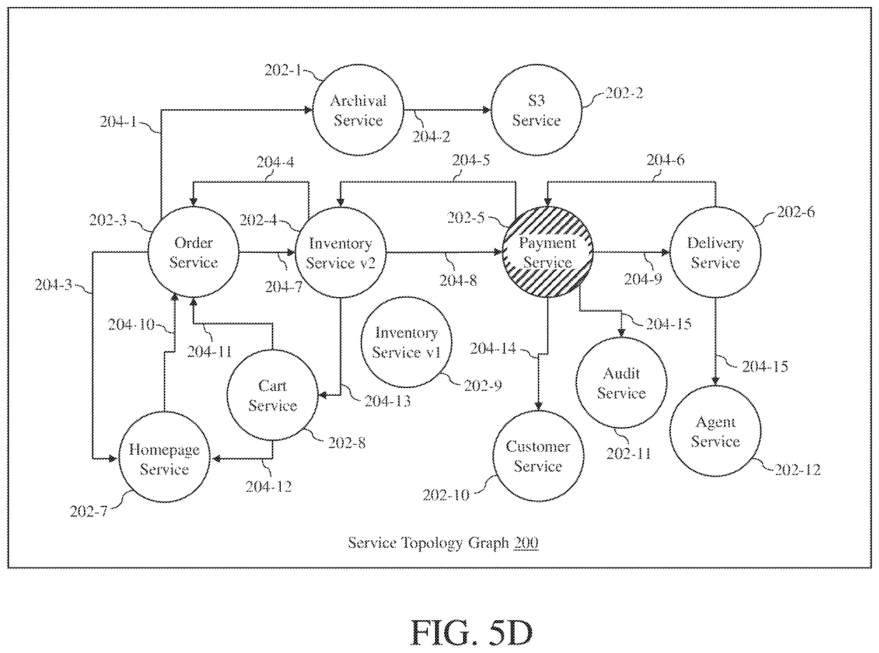

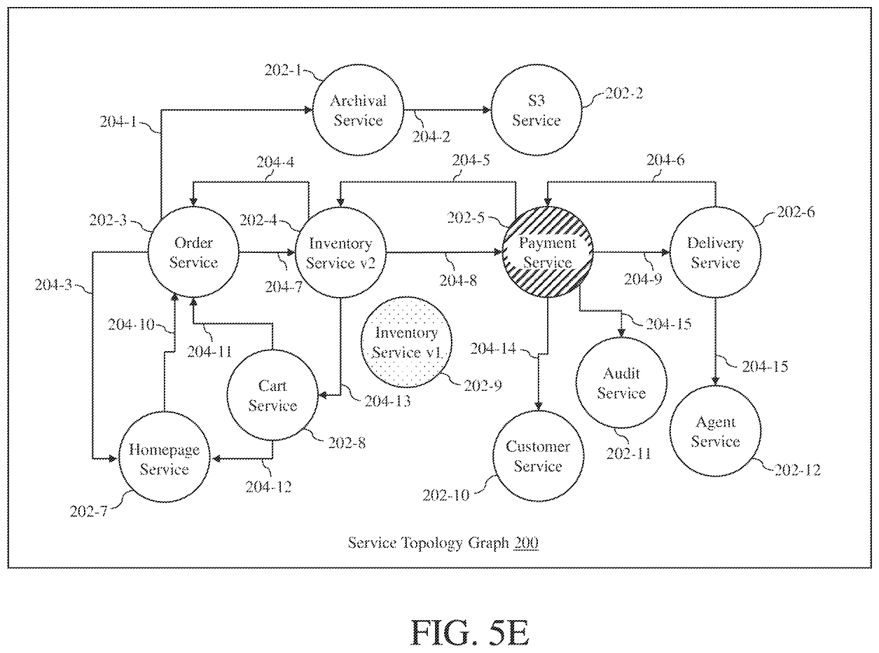

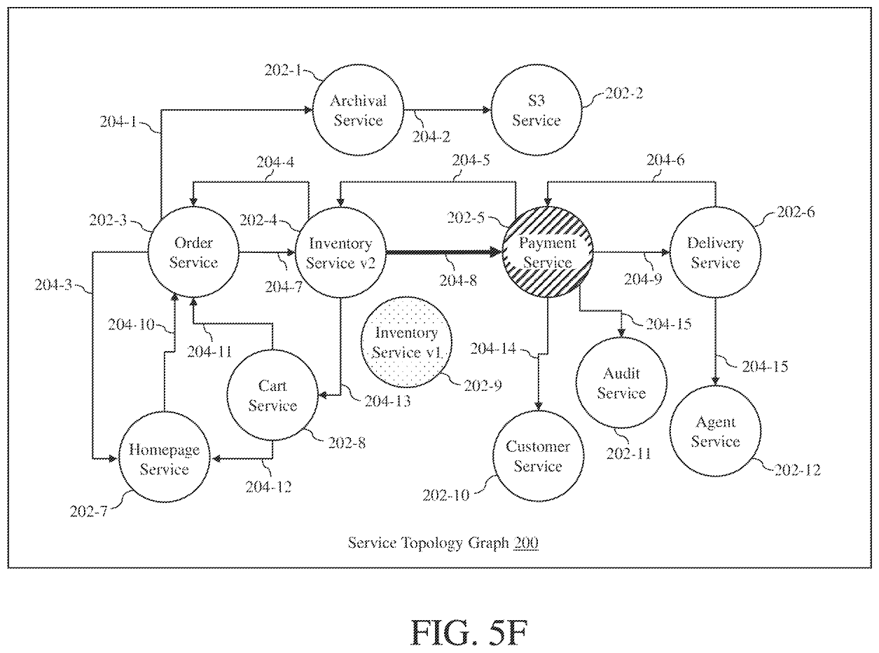

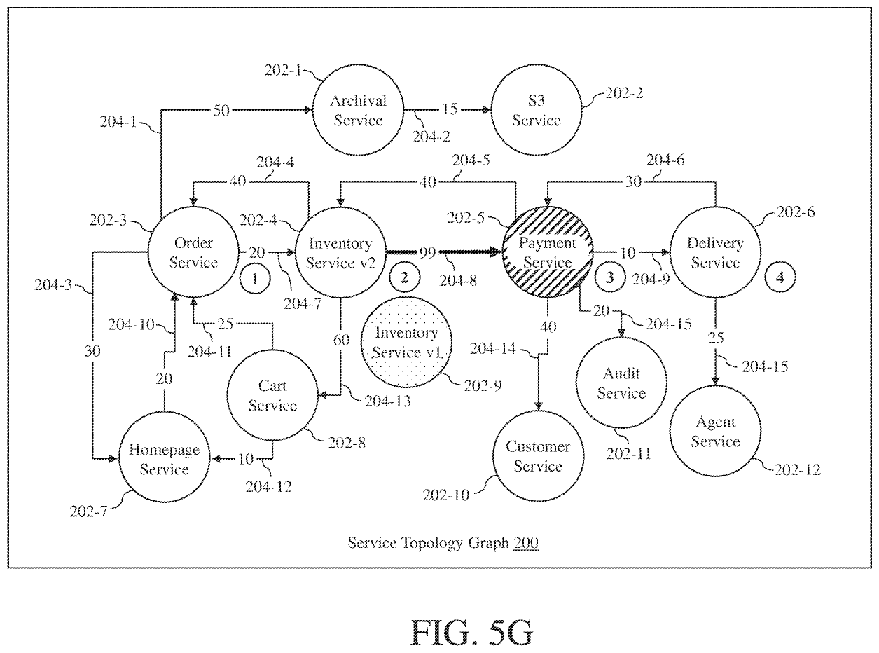

Next, at step 408, an iteration of the traces for the specified time range is started by the service topology engine 112 to process all of the traces. For each trace, a determination is made whether the current trace is the last trace by the service topology engine 112, at step 410. If the current trace is not the last trace, the process proceeds to step 412, where a new node of the service topology graph is created by the service topology engine 112 if a node corresponding to the current trace is not present in the service topology graph being generated. This is illustrated in FIG. 5A, which shows the service topology graph 200 being generated by the service topology engine 112. In FIG. 5A, a new node 202-5 for the payment service is created in the service topology graph 200 being generated, which means that the node 202-4 corresponding to the current trace was not present in the service topology graph being generated.

Next, at step 414, an iteration of the spans from the current trace is started by the service topology engine 112. Next, at step 416, if failure is found in the current span, the node corresponding to the current trace is updated as having a detected failure by the service topology engine 112. This is illustrated in FIG. 5B, which shows the node 202-5 for the payment service in the service topology graph 200 as having a detected failure. The fact that the node 202-5 for the payment service has a detected failure may be visually indicated in the final service topology graph that is rendered. As an example, the node 202-5 for the payment service may be rendered in red.

Next, at step 418, a determination is made whether the current span is the last span in the iteration by the service topology engine 112. If yes, then the last span details for connecting nodes are stored by the service topology engine 112, at step 420. The last span details are needed for connecting nodes. Then, at step 422, the iteration of the spans for the current trace is terminated or stopped by the service topology engine 112. The process then proceeds to process the next trace for the iteration of the traces. Thus, the process proceeds back to step 410 for the next trace being processed. However, if the current span is not the last span, then the process proceeds to step 424.

At step 424, a determination is made whether the current span is the first span of the current trace and the current span includes a parent ID by the service topology engine 112. If no, then the process proceeds to step 422, where the iteration of the spans for the current trace is terminated by the service topology engine 112, and the next trace is processed. However, if the current span is the first span of the current trace and the current span includes a parent ID, then the process proceeds to step 426, where the two nodes corresponding to the last span and the current span are connected and an edge is created between the nodes by the service topology engine 112. The process then proceeds to process the next span for the iteration of the spans. The connecting of two nodes is illustrated in FIG. 5C, which shows the node 202-5 for the payment service being connected to the node 202-4 for the inventory service v2 by the edge 204-8.

Turning back to step 410, if the current trace is the last trace in the iteration, the process proceeds to step 428, where the iteration of traces is stopped by the service topology engine 112. At this point, after iterating through all the traces and their spans, all the nodes and edges in the service topology graph have been created. This is illustrated in FIG. 5D, which shows the service topology graph 200 being generated with all the node and edges.

Next, at step 430, any deprecated nodes in the service topology graph are detected using the service topology graph by the service topology engine 112. In an embodiment, the deprecated nodes that have been detected are visually indicated in the service topology graph. This is illustrated in FIG. 5E, which shows the node 202-9 for the inventory service v1 in the service topology graph 200 as being a deprecated node. As such, the node 202-9 may be visually indicated in the final service topology graph that is rendered, as illustrated in FIG. 5E. As an example, the node 202-9 for the inventory service v1 may be rendered in gray.

Next, at step 432, any network bottlenecks in the service topology graph are detected by the service topology engine. In an embodiment, the network bottlenecks that have been detected are indicated in the service topology graph. As illustrated in FIG. 5F, the edge 204-8 in the service topology graph 200 is detected as a network bottleneck, and is visually indicated in the final service topology graph that is rendered. As an example, the edge 204-8 may be rendered in red.

Next, at step 434, the data of the service topology graph is sent to the user interface 114 by the service topology engine 112 as a response to the received request for the service topology graph. Then, at step 436, the service topology graph is rendered on the user interface 114. As an example, the rendered service topology graph may be similar to the service topology graph shown in FIG. 5F.

In an embodiment, the following algorithm may be used to generate a service topology graph for the data centers.

### Algorithm to Generate Service Topology Graph

```
  Step 1: Initialize
        graph ← HashTable<Node, List<Edge>>
  Step 2: Fetch all distinct trace_ids from give time range in ascending order
        trace_id_set ← select distinct(trace_id) from traces from start_time >
                  $start_time and end_time < $end_time order by start_time asc
  Step 3: For each trace_id ⊆ trace_id_set begin
    Step 3.a: Initialize
              last_span ← NULL
              last_node ← NULL
    Step 3.b: Fetch all traces for given trace id and time range
              traces_list ← select * from traces where trace_id = <trace_id>
    Step 3.c: For each trace ⊆ traces_list begin
      Initialize
      host_name ←trace.host, has_failure ← false; Node ← NULL;
      Step 3.c.a: If (host_name !⊆ graph) then
                      node = create_new_node(host_name)
                End if
      Step 3.c.b: Update trace id information in node data structure
      Step 3.c.c: For each span ⊆ trace.spans begin
        Step 3.c.c.a : Detect if node has failures in them
                      If span.status = = ERROR then
                            has_failure ← TRUE
                        End if
        Step 3.c.c.b: Connect with other nodes in graph
                        If (first span in iteration) & & (span.parent_id.is_empty( )) then
                              Edge = create_new_edge(last_span, last_node)
                              graph.get(last_node).add(edge)
                      End if
        Step 3.c.c.c: Keep track of last span and node details of the trace
                      If (last span in iteration) then
                            last_span ← span
                          last_node ←node
                      End if
                End for
      Step 3.c.d: Update node status if there is any failure found in any span
                node.has_failure ← has_failure;
            End for
          End for
```

The above algorithm uses the data structures defined in the table 300 shown in FIG. 3 and generates a service topology graph based on the traces obtained for a given time range. In step 1, graph data structure is initialized. A hash table is used to represent the graph. In this algorithm, it is assumed that the trace data is stored in Apache Solr as a data store. In step 2, some SQL query is used to fetch all the distinct trace IDs from the data store for a given time range. The query is restricted to a specific time range because it is expected that the time range of failure during a troubleshooting process is known, which helps in reducing the search space.

For each of the trace IDs obtained, parameters last_span and last_node are initialized in step 3(a), and complete trace data are fetched from the data store in step 3(b). As each microservice emits its own trace data, a list of traces which belongs to unique trace ID is obtained (see Table 1 for examples).

In step 3(c), each of the traces or trace data is processed iteratively until all the traces are processed. In this step, the parameters host_name, has_failure and Node are initialized. Based on the hostname of each trace data, a new node is created in the graph in step 3(c)(1) or an existing node (already created) in the graph is updated in step 3(c)(2). Each trace will have N spans which depends on the program path. In step 3(c)(3), each of the spans is processed iteratively until all the spans of the trace are processed.

In step 3(c)(3), three operations are performed for each span of the trace. In In step 3(c)(3)(a), a determination is made whether the current node has failures. Every span has status which represents if there is any failure in the current program path. Thus, if there are any failures, then the has_failure global property is updated in step 3(c)(3)(a). In step 3(c)(3)(b), the current node is connected with all the other nodes in the graph only when the parent ID of the first span is not null and a directed edge is created between two nodes. In step 3(c)(3)(c), the last span is tracked, which is needed in the above step for creating edges between two nodes. Once the span iteration is done for a trace data, the node status is updated to failure accordingly based on has_failure property in step 3(c)(4). The complete service topology derived from the traces of the application can be stored in the graph hash table.

The service topology graph can be used to detect deprecated nodes and network bottlenecks. To detect deprecated nodes, the nodes of the service topology graph are iteratively processed to find nodes without any edges. If there are no edges for any given node, then such nodes can be deprecated. The following algorithm may be used to detect deprecated nodes in the service topology graph.

```
Algorithm - 2.1: Detecting deprecated nodes
  For each (key, value) from graph Begin
    If value.is_empty then
      key.can_be_deprecated ← TRUE
    End if
  End for
```

To detect network bottlenecks, the edges of the service topology graph are iteratively processed to find network bottlenecks. If a request time in any edge crosses the threshold time limit, then the edge is marked as a network bottleneck The following algorithm may be used to detect network bottlenecks in the service topology graph.

```
Algorithm - 2.2: Detect network bottlenecks
  For each edge from graph.edges Begin
    If edge.requestTime > LATENCY_THRESHOLD then
      edge. Is_bottleneck ← TRUE
    End if
  End for
```

In some embodiments, a network latency measure or value may be graphically added to each edge in a service topology graph, which indicates network latency for the connection between two nodes represented by that edge. These network latency values may the request time values found in the span data associated with the edges. In one implementation, the network latency values are weight values from 1-100, where larger numbers represent higher latencies. This is illustrated in FIG. 2, which shows the service topology graph 200 with a weighted network latency value for each edge. The service topology graph generated by the service topology engine 112 may also graphically indicate the data path. As an example, in FIG. 5G, the data path through the microservices when a customer wants to buy a product from ecommerce portal using the order management service application supported by the microservices are numbered 1-4 in the service topology graph 200.

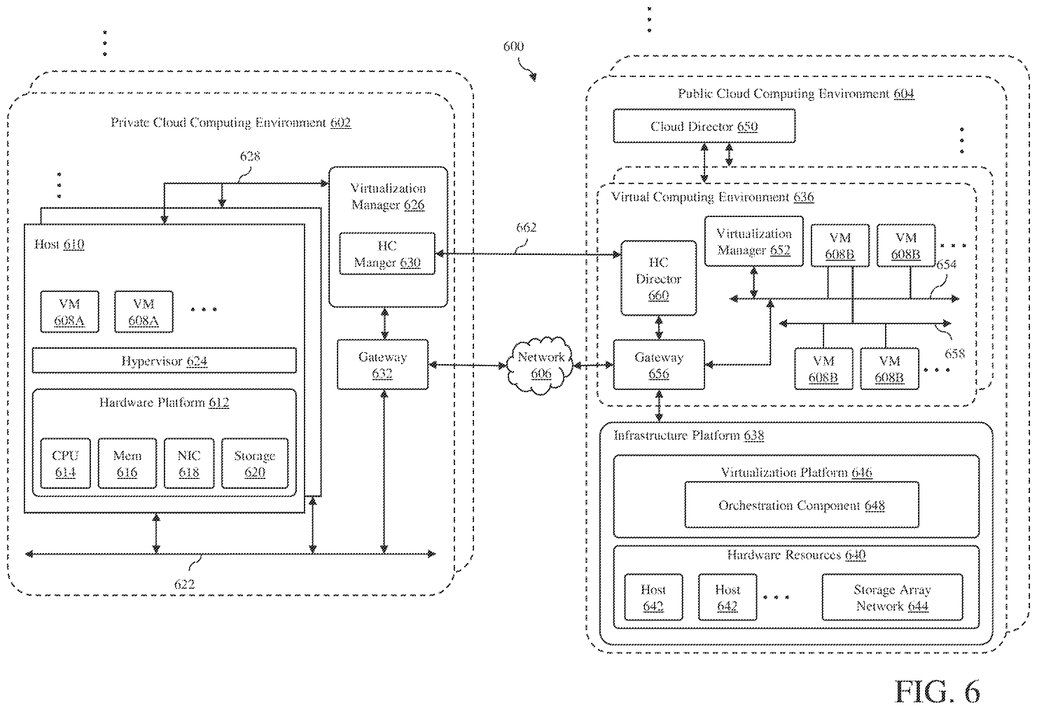

The microservices for which service topology graphs are generated may be implemented in any computing environment. Turning now to FIG. 6, a hybrid cloud computing environment 600 that includes one or more private cloud computing environments 602 and one or more public cloud computing environments 604 in accordance with an embodiment of the invention is shown. The microservices for which service topology graphs are generated may be executing in the hybrid cloud computing environment 600, in one of the private cloud computing environments 602, or in one of the public cloud computing environments 604.

In an embodiment, one or more of the private cloud computing environments 602 may be controlled and administrated by a particular enterprise or business organization, while one or more of the public cloud computing environments 604 may be operated by a cloud computing service provider and exposed as a service available to account holders, such as the particular enterprise in addition to other enterprises. In some embodiments, each private cloud computing environment 602 may be a private or on-premise data center. The private and public cloud computing environments 602 and 604 are connected to each other via a network 606.

The private and public cloud computing environments 602 and 604 of the hybrid cloud computing environment 600 include computing and/or storage infrastructures to support a number of virtual computing instances 608A and 608B. As used herein, the term “virtual computing instance” refers to any software processing entity that can run on a computer system, such as a software application, a software process, a virtual machine (VM), e.g., a VM supported by virtualization products of VMware, Inc., and a software “container”, e.g., a Docker container. However, in this disclosure, the virtual computing instances will be described as being virtual machines, although embodiments of the invention described herein are not limited to virtual machines.

As shown in FIG. 6, each private cloud computing environment 602 includes one or more host computer systems (“hosts”) 610. The hosts may be constructed on a server grade hardware platform 612, such as an x86 architecture platform. As shown, the hardware platform of each host may include conventional components of a computing device, such as one or more processors (e.g., CPUs) 614, system memory 616, a network interface 618 and storage 620. The processor 614 is configured to execute instructions, for example, executable instructions that perform one or more operations described herein and may be stored in the memory 616 and the storage 620. The memory 616 is volatile memory used for retrieving programs and processing data. The memory 616 may include, for example, one or more random access memory (RAM) modules. The network interface 618 enables the host 610 to communicate with another device via a communication medium, such as a network 622 within the private cloud computing environment. The network interface 618 may be one or more network adapters, also referred to as a Network Interface Card (NIC). The storage 620 represents local storage devices (e.g., one or more hard disks, flash memory modules, solid state disks and optical disks) and/or a storage interface that enables the host to communicate with one or more network data storage systems. Example of a storage interface is a host bus adapter (HBA) that couples the host to one or more storage arrays, such as a storage area network (SAN) or a network-attached storage (NAS), as well as other network data storage systems. The storage 620 is used to store information, such as executable instructions, cryptographic keys, virtual disks, configurations and other data, which can be retrieved by the host.

Each host 610 may be configured to provide a virtualization layer that abstracts processor, memory, storage and networking resources of the hardware platform 612 into the virtual computing instances, e.g., the virtual machines 608A, that run concurrently on the same host. The virtual machines run on top of a software interface layer, which is referred to herein as a hypervisor 624, that enables sharing of the hardware resources of the host by the virtual machines. One example of the hypervisor 624 that may be used in an embodiment described herein is a VMware ESXi™ hypervisor provided as part of the VMware vSphere® solution made commercially available from VMware, Inc. The hypervisor 624 may run on top of the operating system of the host or directly on hardware components of the host. For other types of virtual computing instances, the host may include other virtualization software platforms to support those virtual computing instances, such as Docker virtualization platform to support software containers.

Each private cloud computing environment 602 includes a virtualization manager 626 that communicates with the hosts 610 via a management network 628. In an embodiment, the virtualization manager 626 is a computer program that resides and executes in a computer system, such as one of the hosts 610, or in a virtual computing instance, such as one of the virtual machines 608A running on the hosts. One example of the virtualization manager 626 is the VMware vCenter Server® product made available from VMware, Inc. The virtualization manager 626 is configured to carry out administrative tasks for the private cloud computing environment 602, including managing the hosts, managing the virtual machines running within each host, provisioning virtual machines, migrating virtual machines from one host to another host, and load balancing between the hosts.

In one embodiment, the virtualization manager 626 includes a hybrid cloud (HC) manager 630 configured to manage and integrate computing resources provided by the private cloud computing environment 602 with computing resources provided by one or more of the public cloud computing environments 604 to form a unified “hybrid” computing platform. The hybrid cloud manager is configured to deploy virtual computing instances, e.g., virtual machines 608A, in the private cloud computing environment, transfer virtual machines from the private cloud computing environment to one or more of the public cloud computing environments, and perform other “cross-cloud” administrative tasks. In one implementation, the hybrid cloud manager 630 is a module or plug-in to the virtualization manager 626, although other implementations may be used, such as a separate computer program executing in any computer system or running in a virtual machine in one of the hosts. One example of the hybrid cloud manager 630 is the VMware® HCXTM product made available from VMware, Inc.

In one embodiment, the hybrid cloud manager 630 is configured to control network traffic into the network 606 via a gateway device 632, which may be implemented as a virtual appliance. The gateway device 632 is configured to provide the virtual machines 608A and other devices in the private cloud computing environment 602 with connectivity to external devices via the network 606. The gateway device 632 may manage external public Internet Protocol (IP) addresses for the virtual machines 108A and route traffic incoming to and outgoing from the private cloud computing environment and provide networking services, such as firewalls, network address translation (NAT), dynamic host configuration protocol (DHCP), load balancing, and virtual private network (VPN) connectivity over the network 606.

Each public cloud computing environment 604 is configured to dynamically provide an enterprise (or users of an enterprise) with one or more virtual computing environments 636 in which an administrator of the enterprise may provision virtual computing instances, e.g., the virtual machines 608B, and install and execute various applications in the virtual computing instances. Each public cloud computing environment includes an infrastructure platform 638 upon which the virtual computing environments can be executed. In the particular embodiment of FIG. 6, the infrastructure platform 638 includes hardware resources 640 having computing resources (e.g., hosts 642), storage resources (e.g., one or more storage array systems, such as a storage area network (SAN) 644), and networking resources (not illustrated), and a virtualization platform 646, which is programmed and/or configured to provide the virtual computing environments 636 that support the virtual machines 608B across the hosts 642. The virtualization platform may be implemented using one or more software programs that reside and execute in one or more computer systems, such as the hosts 642, or in one or more virtual computing instances, such as the virtual machines 608B, running on the hosts.

In one embodiment, the virtualization platform 646 includes an orchestration component 648 that provides infrastructure resources to the virtual computing environments 636 responsive to provisioning requests. The orchestration component may instantiate virtual machines according to a requested template that defines one or more virtual machines having specified virtual computing resources (e.g., compute, networking and storage resources). Further, the orchestration component may monitor the infrastructure resource consumption levels and requirements of the virtual computing environments and provide additional infrastructure resources to the virtual computing environments as needed or desired. In one example, similar to the private cloud computing environments 602, the virtualization platform may be implemented by running on the hosts 642 VMware ESXi™-based hypervisor technologies provided by VMware, Inc. However, the virtualization platform may be implemented using any other virtualization technologies, including Xen®, Microsoft Hyper-V® and/or Docker virtualization technologies, depending on the virtual computing instances being used in the public cloud computing environment 604.

In one embodiment, each public cloud computing environment 604 may include a cloud director 650 that manages allocation of virtual computing resources to an enterprise. The cloud director may be accessible to users via a REST (Representational State Transfer) API (Application Programming Interface) or any other client-server communication protocol. The cloud director may authenticate connection attempts from the enterprise using credentials issued by the cloud computing provider. The cloud director receives provisioning requests submitted (e.g., via REST API calls) and may propagate such requests to the orchestration component 648 to instantiate the requested virtual computing instances (e.g., the virtual machines 608B). One example of the cloud director is the VMware vCloud Director® product from VMware, Inc. The public cloud computing environment 604 may be VMware cloud (VMC) on Amazon Web Services (AWS).

In one embodiment, at least some of the virtual computing environments 636 may be configured as virtual data centers. Each virtual computing environment includes one or more virtual computing instances, such as the virtual machines 608B, and one or more virtualization managers 652. The virtualization managers 652 may be similar to the virtualization manager 626 in the private cloud computing environments 602. One example of the virtualization manager 652 is the VMware vCenter Server® product made available from VMware, Inc. Each virtual computing environment may further include one or more virtual networks 654 used to communicate between the virtual machines 608B running in that environment and managed by at least one networking gateway device 656, as well as one or more isolated internal networks 658 not connected to the gateway device 656. The gateway device 656, which may be a virtual appliance, is configured to provide the virtual machines 608B and other components in the virtual computing environment 636 with connectivity to external devices, such as components in the private cloud computing environments 602 via the network 606. The gateway device 656 operates in a similar manner as the gateway device 632 in the private cloud computing environments.

In one embodiment, each virtual computing environments 636 includes a hybrid cloud (HC) director 660 configured to communicate with the corresponding hybrid cloud manager 630 in at least one of the private cloud computing environments 602 to enable a common virtualized computing platform between the private and public cloud computing environments. The hybrid cloud director may communicate with the hybrid cloud manager using Internet-based traffic via a VPN tunnel established between the gateway devices 632 and 656, or alternatively, using a direct connection 662. The hybrid cloud director and the corresponding hybrid cloud manager facilitate cross-cloud migration of virtual computing instances, such as virtual machines 608A and 608B, between the private and public computing environments. This cross-cloud migration may include both “cold migration” in which the virtual machine is powered off during migration, as well as “hot migration” in which the virtual machine is powered on during migration. As an example, the hybrid cloud director 660 may be a component of the HCX-Cloud product and the hybrid cloud manager 630 may be a component of the HCX-Enterprise product, which are provided by VMware, Inc.

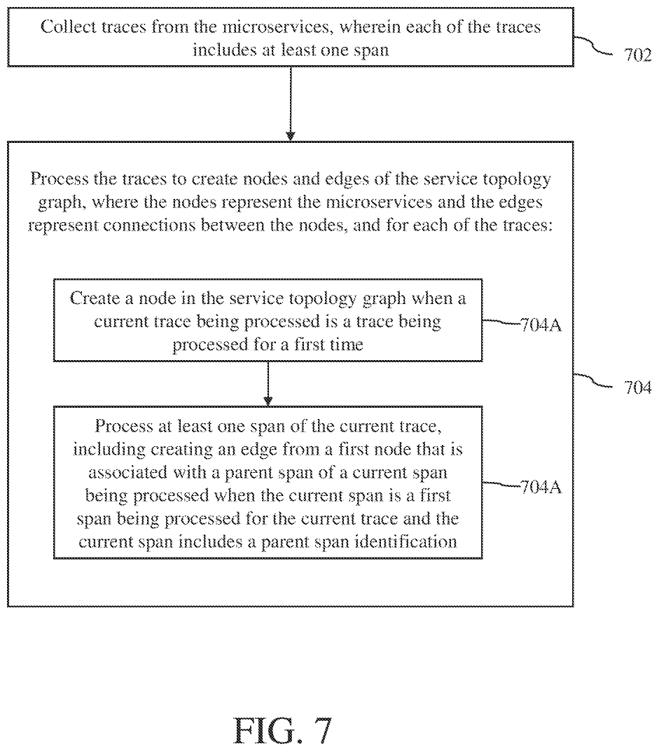

A computer-implemented method for generating a service topology graph for microservices in a computing environment in accordance with an embodiment of the invention is described with reference to a flow diagram of FIG. 7. At block 702, traces are collected from the microservices, wherein each of the traces includes at least one span. At block 704, the traces are processed to create nodes and edges of the service topology graph, where the nodes represent the microservices and the edges represent connections between the nodes. For each of the traces, subblocks x04A and x04B are executed. At subblock 704A, a node is created in the service topology graph when a current trace being processed is a trace being processed for a first time. At subblock 704B, at least one span of the current trace is processed, including creating an edge from a first node that is associated with a parent span of a current span being processed when the current span is a first span being processed for the current trace and the current span includes a parent span identification.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for generating a service topology graph for microservices in a computing environment, the method comprising:
collecting traces from the microservices, wherein each of the traces includes at least one span; and
processing the traces to create nodes and edges of the service topology graph, wherein the nodes represent the microservices and the edges are connections between the nodes, wherein the processing of the traces includes, for each of the traces:
creating a new node in the service topology graph when a current trace being processed is a trace being processed for a first time; and
processing the at least one span of the current trace, including creating an edge between a node that is associated with a parent span of a current span being processed and the new node when the current span is a first span being processed for the current trace and the current span includes a parent span identification.

2. The method of claim 1, further comprising iterating through the nodes of the service topology graph to detect any deprecated node in the service topology graph, wherein a deprecated node is a node without any edge connecting the node to another node in the service topology graph.

3. The method of claim 1, further comprising iterating through the edges of the service topology graph to detect any network bottleneck in the service topology graph, wherein a network bottleneck is an edge with a latency greater than a threshold.

4. The method of claim 3, wherein the latency of the edge is defined as time taken to complete a request from a source node and a destination node, where the source and destination nodes are connected to each other by the edge.

5. The method of claim 1, wherein processing the at least one span of the current trace further includes, when a failure is found in the current span, updating a failure status of a node associated with the current span.

6. The method of claim 1, wherein creating the edge includes connecting the node to the new node using the edge pointing from the node to the new node.

7. The method of claim 1, further comprising graphically adding network latency measures to the edges of the service topology graph.

8. The method of claim 7, wherein the latency measures include numbers in a predefined range, where larger numbers represent higher latencies.

9. A non-transitory computer-readable storage medium containing program instructions for method for generating a service topology graph for microservices in a computing environment, wherein execution of the program instructions by one or more processors of a computer causes the one or more processors to perform steps comprising:
collecting traces from the microservices, wherein each of the traces includes at least one span; and
processing the traces to create nodes and edges of the service topology graph, wherein the nodes represent the microservices and the edges are connections between the nodes, wherein the processing of the traces includes, for each of the traces:
creating a new node in the service topology graph when a current trace being processed is a trace being processed for a first time; and
processing the at least one span of the current trace, including creating an edge between a node that is associated with a parent span of a current span being processed and the new node when the current span is a first span being processed for the current trace and the current span includes a parent span identification.

10. The computer-readable storage medium of claim 9, wherein the steps further comprise iterating through the nodes of the service topology graph to detect any deprecated node in the service topology graph, wherein a deprecated node is a node without any edge connecting the node to another node in the service topology graph.

11. The computer-readable storage medium of claim 9, wherein the steps further comprise iterating through the edges of the service topology graph to detect any network bottleneck in the service topology graph, wherein a network bottleneck is an edge with a latency greater than a threshold.

12. The computer-readable storage medium of claim 11, wherein the latency of the edge is defined as time taken to complete a request from a source node and a destination node, where the source and destination nodes are connected to each other by the edge.

13. The computer-readable storage medium of claim 9, wherein processing the at least one span of the current trace further includes, when a failure is found in the current span, updating a failure status of a node associated with the current span.

14. The computer-readable storage medium of claim 9, wherein creating the edge includes connecting the node to the new node using the edge pointing from the node to the new node.

15. The computer-readable storage medium of claim 9, wherein the steps further comprise graphically adding network latency measures to the edges of the service topology graph.

16. The computer-readable storage medium of claim 15, wherein the latency measures include numbers in a predefined range, where larger numbers represent higher latencies.

17. A system comprising:
memory; and
at least one processor configured to:
collect traces from microservices in a computing environment, wherein each of the traces includes at least one span; and
process the traces to create nodes and edges of a service topology graph for the microservices, wherein the nodes represent the microservices and the edges are connections between the nodes, wherein the at least one process is configured to, for each of the traces:
create a new node in the service topology graph when a current trace being processed is a trace being processed for a first time; and
process the at least one span of the current trace, including creating an edge between a node that is associated with a parent span of a current span being processed and the new node when the current span is a first span being processed for the current trace and the current span includes a parent span identification.

18. The system of claim 17, wherein the at least one processor is configured to iterate through the nodes of the service topology graph to detect any deprecated node in the service topology graph, wherein a deprecated node is a node without any edge connecting the node to another node in the service topology graph.

19. The system of claim 17, wherein the at least one processor is configured to iterate through the edges of the service topology graph to detect any network bottleneck in the service topology graph, wherein a network bottleneck is an edge with a latency greater than a threshold.

20. The system of claim 19, wherein the latency of the edge is defined as time taken to complete a request from a source node and a destination node, where the source and destination nodes are connected to each other by the edge.
